(19) United States
(12) Patent Application Publication
(10) Pub. No.: US 2020/0005184 A1
(43) Pub. Date: Jan. 2, 2020

(54) SKILL GENERATING METHOD, APPARATUS, AND ELECTRONIC DEVICE

(71) Applicant: ALIBABA GROUP HOLDING LIMITED, GRAND CAYMAN (KY)

(72) Inventors: Yong LIU, HANGZHOU (CN); Zhiyu CHEN, HANGZHOU (CN); Qiang ZHANG, HANGZHOU (CN)

(21) Appl. No.: 16/453,455

(22) Filed: Jun. 26, 2019

(30) Foreign Application Priority Data
Jun. 27, 2018 (CN) 201810682456.9

(51) Int. Cl. G06N 20/00; G06N 5/02

(52) U.S. Cl. CPC G06N 20/00; G06N 5/022

(57) ABSTRACT

Embodiments of the specification provide a skill generating method, apparatus, and electronic device, wherein the skill generating method comprises: generating, according to a demand creating instruction and demand content data, a task corresponding to distribution target information; creating a material library according to a response instruction that responds to the task corresponding to the distribution target information; and determining a training material from the material library according to a skill training instruction to generate a skill according to the training material. Embodiments of the specification can improve the skill development efficiency.

### CROSS-REFERENCE TO RELATED APPLICATIONS

The present application is based on and claims priority to the Chinese Patent Application No. 201810682456.9, filed on Jun. 27, 2018 and entitled “Skill Generating Method, Apparatus, and Electronic Device,” which is incorporated herein by reference in its entirety.

### TECHNICAL FIELD

Embodiments of the specification relate to the field of computer technologies, and in particular, to a skill generating method, apparatus, and electronic device.

### BACKGROUND

With the development of science and technology and progress of the times, research on artificial intelligence has been attracting increasingly more attention. Moreover, there are more and more applications of artificial intelligence, such as intelligent dialogue robots, voice assistant, etc. These types of applications of artificial intelligence can implement functions such as voice control, conversations with users, etc. Existing processes for developing applications of artificial intelligence are complicated and involve many development links. Furthermore, developers are required to make repetitive efforts at many development links, leading to a high workload and a low development efficiency. In addition, the high number of application development links makes it very difficult for developers to cooperate among themselves, impossible to effectively monitor development deadlines, and not easy to determine a development timeline, thereby significantly affecting the development efficiency.

### SUMMARY

In view of this, embodiments of the specification provide a skill generating method, apparatus, and electronic device to solve the problem of low development efficiency in current technologies.

According to a first aspect of the embodiments of the specification, a skill generating method is provided. The skill generating method may comprise: generating, according to an obtained demand creating instruction and demand content data, a task corresponding to distribution target information; creating a material library according to a response instruction that responds to the task corresponding to the distribution target information; and determining a training material from the material library according to a skill training instruction to generate a skill according to the training material.

In some embodiments, the method may further comprise: testing the generated skill according to a skill testing instruction, and generating a testing result; and generating a skill releasing instruction or a re-processing instruction according to the testing result.

In some embodiments, a skill releasing instruction is generated according to the testing result. The method may further comprise: generating skill releasing information according to the skill releasing instruction, wherein the skill releasing information comprises the generated skill, and a script version and a training material version corresponding to the generated skill.

In some embodiments, the response instruction comprises at least one of the following: an entity creating instruction, a natural language processing instruction, a script generating instruction, a natural language generating instruction, and a call interface generating instruction.

In some embodiments, the response instruction comprises an entity creating instruction, and the creating a material library according to a response instruction responding to the task comprises: generating an entity in a dictionary of the material library according to the entity creating instruction, wherein the entity comprises an entity name and an entity attribute value.

In some embodiments, the response instruction comprises a natural language processing instruction, and the creating a material library according to a response instruction responding to the task comprises: analyzing a corpus through a natural language processing algorithm according to the natural language processing instruction; and generating intent data according to the analyzed corpus and storing the intent data in the material library, wherein the intent data comprises intent identifier (ID), intent names, and slots.

In some embodiments, the response instruction further comprises a script generating instruction, and the creating a material library according to a response instruction responding to the task further comprises: generating script data according to the intent data and a preset script template and storing the script data in the material library.

In some embodiments, the determining a training material from the material library according to a skill training instruction to generate a skill according to the training material comprises: generating a plurality of intents according to corpora in the training materials; training an operation determining model and script data by using the plurality of intents, the operation determining model being used to determine an operation in response to an intent; and generating an application comprising the skill according to the trained operation determining model and script data.

In some embodiments, the training script data by using the plurality of intents comprises: for each of the plurality of intents, determining corresponding script data according to the intent being currently processed; and in response to determining that the intent being currently processed is a new intent, updating the script data according to the intent being currently processed to add script content corresponding to the new intent into the script data, until all of the plurality of intents are traversed.

According to a second aspect of the embodiments of the specification, a skill generating apparatus is provided. The skill generating apparatus may comprise one or more processors and one or more non-transitory computer-readable memories coupled to the one or more processors and configured with instructions executable by the one or more processors to cause the system to perform operations comprising: generating, according to a demand creating instruction and demand content data, a task corresponding to distribution target information; creating a material library according to a response instruction that responds to the task corresponding to the distribution target information; and determining a training material from the material library according to a skill training instruction to generate a skill according to the training material.

According to a third aspect of the embodiments of the specification, a non-transitory computer-readable storage medium configured with instructions executable by one or more processors to cause the one or more processors to perform operations comprising: generating, according to a demand creating instruction and demand content data, a task corresponding to distribution target information; creating a material library according to a response instruction that responds to the task corresponding to the distribution target information; and determining a training material from the material library according to a skill training instruction to generate a skill according to the training material.

According to a fourth aspect of the embodiments of the specification, an electronic device is provided, comprising: a processor, a memory, a communication interface, and a communication bus, the processor, the memory, and the communication interface achieving mutual communications via the communication bus, the memory being configured to store executable instructions. The executable instructions may cause the processor to perform operations corresponding to the skill generating method according to the first aspect.

The skill generating solutions provided by the embodiments of the specification can achieve online skill development and generation, enabling a full-link flow from demand creation to skill generation in a skill generation process to be completed online, making the monitoring of deadlines in the skill generation process more convenient, and the skill generation process traceable.

### BRIEF DESCRIPTION OF THE DRAWINGS

To more clearly describe the technical solutions in the embodiments of the specification, accompanying drawings for the embodiments will be briefly described. Obviously, the accompanying drawings in the description below are merely to illustrate some embodiments of the specification, and one of ordinary skill in the art may obtain other drawings according to the accompanying drawings.

FIG. 1 is a flow chart of a skill generating method according to some embodiments of the specification;

FIG. 2 is a flow chart of a skill generating method according to other embodiments of the specification;

FIG. 3 is a structural block diagram of a skill generating apparatus according to some embodiment of the specification;

FIG. 4 is a structural block diagram of a skill generating apparatus according to other embodiments of the specification;

FIG. 5 is a schematic structural diagram of an electronic device according to some embodiments of the specification.

### DETAILED DESCRIPTION

To enable one of ordinary skill in the art to better understand the technical solutions in the embodiments of the specification, the technical solutions in the embodiments of the specification will be described in detail below with reference to the accompanying drawings in the embodiments of the specification. The described embodiments are merely some, but not all, embodiments of the specification. On the basis of the embodiments of the specification, all other embodiments obtainable by one of ordinary skill in the art shall fall within the scope of the embodiments of the specification.

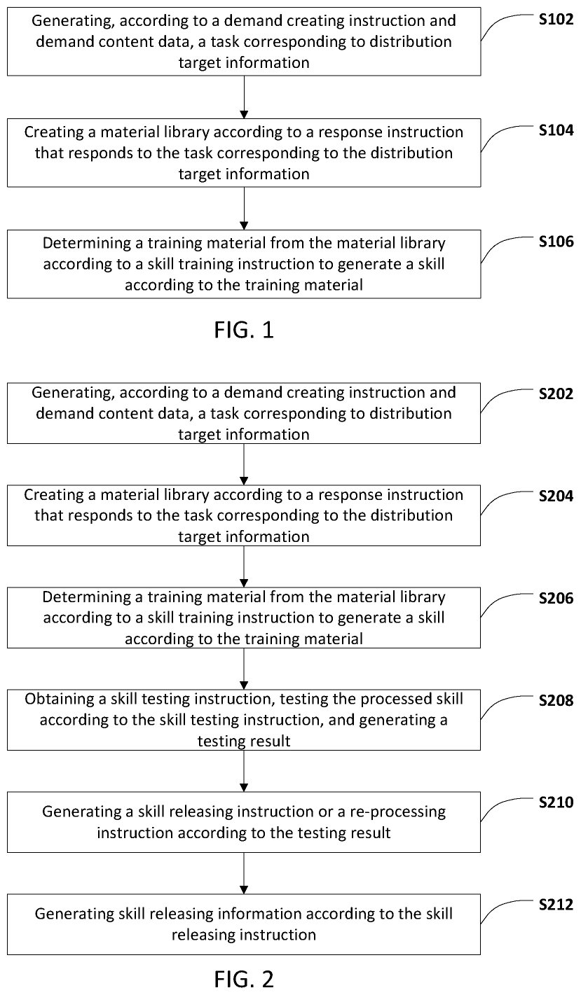

Referring to FIG. 1, a flow chart of a skill generating method is illustrated according to some embodiments of the specification. In the illustrated embodiments, skills refer to functions that can be implemented by voice interaction applications or devices having voice interaction functions, such as inquiry (or also called search) type skills, service type skills, game type skills, chat type skills, etc. For example, the inquiry type skills may include, but are not limited to, skills of weather inquiry, route inquiry, inquiry of common knowledge of daily life, etc. The service type skills include, but are not limited to, restaurant reservation skills, ride hailing skills, payment skills, etc. The game type skills include, but are not limited to, skills of idiom solitaire, quiz games, word puzzles, etc.

Skill generation is also referred to as skill development, which refers to generating or developing a dialogue script, and performing voice interaction with a user according to the dialogue script, so as to obtain information for implementing functions. In some embodiments, the skill generating method may be applicable on a skill generating platform to conduct skill development through a multi-link cooperation, and achieve online skill development, thereby making it easier to monitor and trace the skill development process. In some other embodiments, the skill generating method may also be applicable in other scenarios to develop skills. In the illustrated embodiments, a dialogue skill generating method may include the following steps S102-S106.

Step S102: generating, according to a demand creating instruction and demand content data, a task corresponding to distribution target information.

The demand creating instruction may indicate a demand for generating or developing a new skill. The demand for the new skill development may include a demand for a product. A skill development platform applying the skill generating method may provide an interface for a user to generate a demand creating instruction. For example, the platform may enable the user to click a demand creating button on the interface to generate the demand creating instruction.

The demand content data describes information about the demand. For example, the demand content data includes, but is not limited to, basic demand information, demand description, crowdsourcing survey option, supplementary content, remark content, task deadlines, task description, task types, task leaders, etc. In some embodiments, the demand content data may include some or all of the above-described data.

In some embodiments, the basic demand information includes, but is not limited to, a skill name, demand background description, a launch time, etc. The demand description may describe effects to be achieved by the skill in demand and the like. The crowdsourcing survey option may indicate whether crowdsourcing survey is needed. The supplementary content may be provided by the user when the user is to fill in additional description. The user may be allowed to determine whether to fill in the supplementary content. The task deadlines may indicate one or more desired completion times. The task description may include task content, task goal, etc. The task types may include, but are not limited to, entity creating task, natural language processing task, script generating task, natural language generating task, and open interface generating task. The task leader data may indicate a person who executes or monitors the one or more tasks.

In some embodiments, at least one task and distribution target information corresponding to the task are generated according to the demand creating instruction and corresponding demand content data. For example, the demand creating instruction instructs to create a weather inquiry skill. According to the demand creating instruction and corresponding demand content data, corresponding tasks may be generated, for example, including, but not limited to, an entity creating task, a natural language processing task, a script generating task, a natural language generating task, and an open interface generating task. In some embodiments, the generated tasks may include one or more of the examples of tasks listed above.

The distribution target information may indicate a task receiver corresponding to each task generated according to the demand content data. For example, an entity creating task is generated according to the demand content data, the corresponding task leader is Xiao Ming, and then the distribution target information indicates that the task receiver corresponding to the task is Xiao Ming.

After the demand creating instruction and corresponding demand content data are obtained and after the distribution target information and the tasks are generated according to the demand creating instruction and corresponding demand content data, the tasks, distribution target information, task description, and the like may be displayed through an interface to facilitate viewing information related to the tasks and monitoring the progress.

Step S104: creating a material library according to a response instruction that responds to the task corresponding to the distribution target information.

After the task and the distribution target information are generated, an evaluation of the task may be performed to determine whether to amend the task deadlines, whether the task description is accurate, etc. In some embodiments, the platform may allow the user to perform the evaluation of the task. If the task evaluation by the user is passed, the task may be distributed to a corresponding task leader according to the distribution target information. In some other embodiments, the task evaluation by a user may be omitted, and the task is distributed according to the distribution target information. Each task leader may check information of the one or more tasks which he or she executes or monitors, states of the one or more tasks, and the like, from the display interface of the skill development platform. In some embodiments, the display interface of the skill development platform may be used to generate a response instruction responding to a task, so as to complete the task and create a material library for skill generation.

For different types of tasks, the response instructions may have different contents. Different task leaders may receive different types of tasks, and therefore send different response instructions after completion of the received tasks. For example, a response instruction for an entity creating task may be an entity creating instruction, a response instruction for a natural language processing task may be a natural language processing instruction, etc. In some embodiments, the response instructions may include, but are not limited to, one or more of an entity creating instruction, a natural language processing instruction, a script generating instruction, a natural language generating instruction, and a call interface generating instruction. In some embodiments, the skill generating method may divide the task of creating a material library into multiple tasks and sends the tasks to the same or different task leaders, which helps improve the task completion efficiency and facilitates task management. In some embodiments, the material library may include, but is not limited to, entities in a dictionary, intent files, script files, natural language templates, corpora, etc.

In some embodiments, the material library may store materials to be used in the skill generating process, such as corpora, script data, entities, etc. Entities may include proper nouns and/or common nouns. For example, an entity may include a set of standard natural language phrases, including, for example, people's names, place names, times, etc. For example, a place name may have entity values such as Hangzhou, Shenzhen, Shanghai, etc.

A corpus may be a structured set of texts or text data in one or more languages. In some embodiments, the corpus may refer to queries in an intelligent dialogue. The corpus may include data formed by these queries and include a user's intent (i.e., a purpose). The intent may be an important basis for determining whether the corpus input by a user uses a service to solve the user's problem. The intent represents a mapping from the user's demand to the service.

Step S106: determining a training material from the material library according to a skill training instruction to generate a skill according to the training material.

In some embodiments, a skill may be trained and generated according to training materials in a material library. The skill training instruction may include a skill to be generated and trained, an application scenario, and a corresponding training material. The skill to be generated and trained may be an inquiry type skill, a service type skill, a game type skill, etc. The application scenario may be a scenario where the skill is applied, such as application on a device with or without a screen. For example, the device without a screen may be an intelligent sound system and the like, and the device with a screen may be an intelligent TV, a smart phone, and the like.

In some embodiments, the training material may be a material in the material library created in the step S104. The skill development platform may provide an interface for the user to generate the skill training instruction by, for example, clicking a skill training button on the interface to generate the skill training instruction. On the interface of the skill development platform, detailed information of the skill to be generated and trained may be selected, and corpus files, script files, and the like in the material library may also be selected for generating and training the skill. These files may be differentiated by using file versions as identifiers. A corpus file may include a corpus. A script file may include script data. In the material library, the corpus files may have one or more versions, and the script files may also have one or more versions. After the skill generation and training is activated, the skill generation and training may be performed according to corpus indicated by a selected corpus file and script data indicated by a selected script file.

For example, a weather inquiry type skill is selected through the interface of the skill development platform, and is applied on a device without a screen; and corresponding corpus files and script files are selected to generate a skill training instruction. According to the skill training instruction, materials such as corpus indicated by the corpus file, script data indicated by the script file, and a preset operation determining model are obtained, and the weather inquiry skill is generated and trained according to these materials.

In an example of a training process, according to the obtained corpus, an intent corresponding to the corpus is generated, such as “check weather.” A preset operation determining model may be trained according to the intent. For example, the intent is used as an input to the operation determining model, and the operation determining model outputs a responsive operation corresponding to the intent (i.e., the model determines what operation is to be invoked). The parameters of the operation determining model are adjusted according to outputs, enabling the operation determining model to accurately output a responsive operation corresponding to the intent. Further, corresponding script data may be determined according to the intent. The script data may describe a dialogue process such that data for filling slots of the intent may be obtained. In some embodiments, if the intent is a new intent, the script data is updated according to the new intent so as to add script content corresponding to the new intent into the script data. After all corpora are traversed, an application including the skill is generated according to the trained operation determining model and the updated script data.

For example, the corpus is “how is today's weather.” The corresponding intent may be generated according to the corpus as “check weather.” The slots of the intent may include “city,” “time,” etc. A dialogue may be conducted with a user based on the script data to obtain city information and time information, then a responsive operation is invoked to determine weather information according to the city information and time information, and the weather information are fed back to the user.

The skill generating method according to the embodiments may achieve online skill development and generation, enabling a full-link flow from demand creation to skill generation in a skill generation process to be completed online, making the monitoring of deadlines in the skill generation process to be more convenient, and the skill generation process traceable.

The skill generating method according to the embodiments may be executed by any proper terminal device or server having data processing capabilities, including but not limited to, a mobile terminal such as a tablet computer, a mobile phone, etc., a desktop computer, etc.

Referring to FIG. 2, a flow chart of a skill generating method is illustrated according to other embodiments of the specification. The skill generating method according to the embodiments may be applicable on a skill generating platform to conduct skill development through a multi-link cooperation, and achieve online skill development, thereby making it easier to monitor and trace the skill development process. In some other embodiments, the skill generating method may also be applicable in other scenarios to develop skills. The skill generating method according to the embodiments may include the following steps S202-S212.

Step S202: generating, according to a demand creating instruction and demand content data, a task corresponding to distribution target information.

In some embodiments, the demand creating instruction may indicate a demand for developing a new skill. A skill development platform applying the skill generating method may provide an interface for a user to generate a demand creating instruction. For example, the platform may enable the user to click a demand creating button on the interface to generate the demand creating instruction.

This way, a structured demand for a task can be generated online. The online generation of task demands helps unified management of task demands. Further, the online generation of task demands also facilitates a multi-node cooperation and the monitoring of the task demands' deadlines. In addition, structured task demands further helps use and review by subsequent nodes.

A task demand template may be pre-fabricated in the skill development platform. After the demand creating instruction is generated through the operation interface, the skill development platform may call and display the pre-fabricated task demand template for the user to fill in. The demand content data is obtained from the task demand template filled by the user.

The demand content data may include, but is not limited to, basic information, demand description, crowdsourcing survey option, supplementary content, remark content, task deadlines, task description, task types, task leaders, etc. In some embodiments, the demand content data may include some or all of the above-described data. The meaning and content of each data item in the demand content data have been described in detail with reference to FIG. 1 and will not be elaborated again.

Step S204: creating a material library according to a response instruction that responds to the task corresponding to the distribution target information.

As described above with reference to FIG. 1, in some embodiments, the material library may store materials to be used in the skill generating process, such as corpora, script data, entities, etc. Entities may include proper nouns and/or common nouns. For example, an entity may include a set of standard natural language phrases, including, for example, people's names, place names, times, etc. For example, a place name may have entity values such as Hangzhou, Shenzhen, Shanghai, etc.

A corpus may be a structured set of texts or text data in one or more languages. In some embodiments, the corpus may refer to queries in an intelligent dialogue. The corpus may include data formed by these queries and include a user's intent (i.e., a purpose). The intent may be an important basis for determining whether the corpus input by a user uses a service to solve the user's problem. The intent represents a mapping from the user's demand to the service.

For example, the corpus input by a user includes “what is the degree today,” indicating that the user's intent is to check temperature. Thus, an inquiry type skill can be used to satisfy this intent. To satisfy the user's intent, e.g., telling the user the temperature of the location where the user is, some information, such as the user's location, time, etc., is to be learned. For example, the information may be obtained by conducting a dialogue with the user. A dialogue script may be created and the information may be obtained by conducting a dialogue according to the dialogue script. The dialogue script may include a descriptive file that describes a dialogue process.

If an evaluation of the task demand by the user is passed, the task may be generated and distributed to a corresponding task leader according to the distribution target information. In some other embodiments, the task demand evaluation by a user may be omitted, and the task is generated and distributed according to the distribution target information. Each task leader may check information of the one or more tasks which he or she executes or monitors, states of the one or more tasks, and the like, from the display interface of the skill development platform. In some embodiments, the display interface of the skill development platform may be used to generate a response instruction responding to a task, so as to complete the task and create a material library for skill generation.

For different task types, the response instructions may have different contents. For example, a response instruction for an entity creating task may be an entity creating instruction, a response instruction for a natural language processing task may be a natural language processing instruction, etc. In some embodiments, the response instructions may include, but are not limited to, one or more of an entity creating instruction, a natural language processing instruction, a script generating instruction, a natural language generating instruction, and a call interface generating instruction. In some embodiments, the material library may include, but is not limited to, entities in a dictionary, intent files, script files, natural language templates, etc.

An example of the process for creating a material library will be described in detail below.

For an entity creating task, the skill development platform may provide an interface for the user to operate on a task processing button so as to activate task processing and generate a response instruction. Correspondingly, the response instruction may be an instruction for creating entities.

In some embodiments, an entity in a dictionary of the material library may be generated according to the entity creating instruction. For example, the entity may include an entity name and entity attribute values. A dictionary management module of the skill development platform may create entities, such as creating a new entity, filling in basic information like an entity name. Entity content data may be uploaded and used as entity attribute values, and a concurrent version of the newly created entity may be saved. For example, an entity having an entity name of “place name” is created, and the entity content data, such as “Beijing,” “Hangzhou,” “London,” etc., is uploaded as entity attribute values.

For a natural language processing task, the skill development platform may provide an interface for the user to operate on the task processing button so as to activate task processing and generate a response instruction. Correspondingly, the response instruction may be an instruction for natural language processing. To perform natural language processing, the skill development platform may enable the user to upload corpora through an interface and release a version of corpus. Corpora corresponding to different versions may be different. For example, releasing a version of corpus may include: analyzing the obtained corpus through a natural language processing algorithm (NLU algorithm), generating intent data according to the analyzed corpus, and generating an intent version file according to the intent data. The intent data may include an intent identifier (ID), an intent name, and slots, which can be stored in the material library.

For each piece of the intent data, the intent ID is a unique identifier of the intent, which may be an order number. The intent name may describe the intent's content. For example, NBA_PLAYER_GAME_INFO indicates that this intent is related to game information of NBA players. A slot is a keyword for implementing the intent, such as nba_player (player information), nba_stat_info (game data information). If an intent's name is weather_inquiry, the intent is to conduct a weather_inquiry. The slots may include “city” and “time,” and thus the keywords include a city and a time.

For a script generating task, the skill development platform may provide an interface for the user to operate on the task processing button so as to activate task processing and generate a response instruction. Correspondingly, the response instruction may include a script generating instruction. During script generation, after the intent data is generated according to the analyzed corpus, script data is generated according to the intent data and a preset script template and stored in the material library, and a script version file is generated according to the script data. In some embodiments, the script data may be generated according to the intent data and the slots in each of the intents. The script version file may be organized and stored according to the skill's name or application scenario to facilitate searching and calling.

For a natural language generating task, the skill development platform may provide an interface for the user to operate on the task processing button so as to activate task processing and generate a response instruction. Correspondingly, the response instruction may include a natural language generating instruction. Natural language generation is performed by configuring trigger words, types, items, etc. of a preset natural language template.

For an open interface generating task, the skill development platform may provide an interface for the user to operate on the task processing button so as to activate task processing and generate a response instruction. For example, a third party http service may be called, a corresponding http address, input parameters and output parameters are filled in, and openapi is formed. The openapi is an open interface, an interface for calling a service, and an interface requested by the user in an interaction process after the user inputs the corpus, hits an intent and provides a slot.

Step S206: determining a training material from the material library according to a skill training instruction to generate a skill according to the training material.

In some embodiments, a skill may be trained and generated according to training materials in a material library. The skill training instruction may include a skill to be generated and trained, an application scenario, and a corresponding training material. The skill to be generated and trained may be an inquiry type skill, a service type skill, a game type skill, etc. The application scenario may be a scenario where the skill is applied, such as application on a device with or without a screen. For example, the device without a screen may be an intelligent sound system and the like, and the device with a screen may be an intelligent TV, a smart phone, and the like.

The skill development platform may provide an interface for the user to generate the skill training instruction. On the interface of the skill development platform, a skill to be generated and trained may be selected, and a corpus version file, a script version file, and the like in the material library may also be selected for generating and training the skill.

Multiple intents may be generated according to corpora in the training materials; the intents may be used to train a preset operation determining model and script data; and an application including the skill may be generated according to the trained operation determining model and script data.

In some embodiments, the preset operation determining model is used to determine an operation in response to an intent. When the intents are used to train script data, for each of the multiple intents, corresponding script data is determined according to the intent being currently processed; if the intent being currently processed is a new intent, the script data is updated according to the new intent so as to add script content corresponding to the new intent into the script data, until all intents are traversed, so as to complete the script data training.

An example of the training process will be provided below. According to the obtained corpus, an intent corresponding to the corpus is generated, such as “check weather.” A preset operation determining model may be trained according to the intent. For example, the intent is used as an input to the operation determining model, and the operation determining model outputs a responsive operation corresponding to the intent (i.e., the model determines what operation is to be invoked). The parameters of the operation determining model are adjusted according to outputs, enabling the operation determining model to accurately output a responsive operation corresponding to the intent. Further, corresponding script data may be determined according to the intent. The script data may describe a dialogue process such that data for filling slots of the intent may be obtained. In some embodiments, if the intent is a new intent, the script data is updated according to the new intent so as to add script content corresponding to the new intent into the script data. After all corpora are traversed, an application including the skill is generated according to the trained operation determining model and the updated script data. In some embodiments, when the corresponding script content is updated through the new intent, one or more script version files may be generated.

For example, the corpus is “how is today's weather.” The corresponding intent may be generated according to the corpus as “check weather.” The slots of the intent may include “city,” “time,” etc. A dialogue may be conducted with a user based on the script data to obtain city information and time information, then a responsive operation is invoked to determine weather information according to the city information and time information, and the weather information are fed back to the user.

Step S208: obtaining a skill testing instruction, testing the processed skill according to the skill testing instruction, and generating a testing result.

After the application including the skill is generated, the skill development platform may allow the user to generate the skill testing instruction by operating on a skill testing button on an interface. A skill testing task may be generated according to the skill testing instruction and sent to a corresponding testing task leader to test the skill.

In some embodiments, the test may include a dialogue test and an effect verification. When the dialogue test is being performed, the application including the skill is called, a pop-up interface is displayed, and a skill, such as a history inquiry skill, is selected in a pop-up interface. A query is input in the pop-up interface, and it is verified whether a corresponding response has met the expectation, so as to generate a verification result.

Step S210: generating a skill releasing instruction or a re-processing instruction according to the test result.

If the verification result indicates that the expectation has been met, a skill releasing instruction is generated; if the verification result indicates that the expectation has not been met, a re-processing instruction is generated.

If the re-processing instruction is generated, the step S206 is repeated for skill training. If the releasing instruction is generated, the step S212 is executed.

Step S212: generating skill releasing information according to the skill releasing instruction, wherein the skill releasing information comprises the processed skill, and a script version and a training material corresponding to the processed skill.

According to the skill releasing instruction, the skill development platform may enable the user to select a successful version of the skill training and testing stage and correlate a corpus version file (the corpus indicated by the corpus version file may include all or some corpora in the material library) with a script version file (the script data indicated by the script version file may include all or some script content) corresponding to the version. A skill releasing “pub” process is entered. The “pub” process is substantially the same as the skill training process and will not be elaborated again. After pushing the pub process is successfully trained, a function testing process of the skill development platform is called, and a pre-fabricated testing script is used for testing, and online release is performed after the testing is successful.

The online environment for skill pushing has the same process nodes as those of the skill training. A series of operations, such as creating an intent—creating a skill—updating a script—creating an application—training the application, are performed in the online environment, thereby completing the online skill development.

Therefore, according to the skill generating method in the embodiments, the skill development platform is used to achieve online skill development, and the problem in the existing skill development solutions that tasks on various links cannot be coordinated and monitored is solved by a task stream form. A closed loop of demand creation—skill generation—training—testing—release—iteration is formed, thereby improving the skill production efficiency.

The skill generating method according to the embodiments may be executed by any proper terminal device or server having data processing capabilities, including but not limited to, a mobile terminal such as a tablet computer, a mobile phone, etc., a desktop computer, etc.

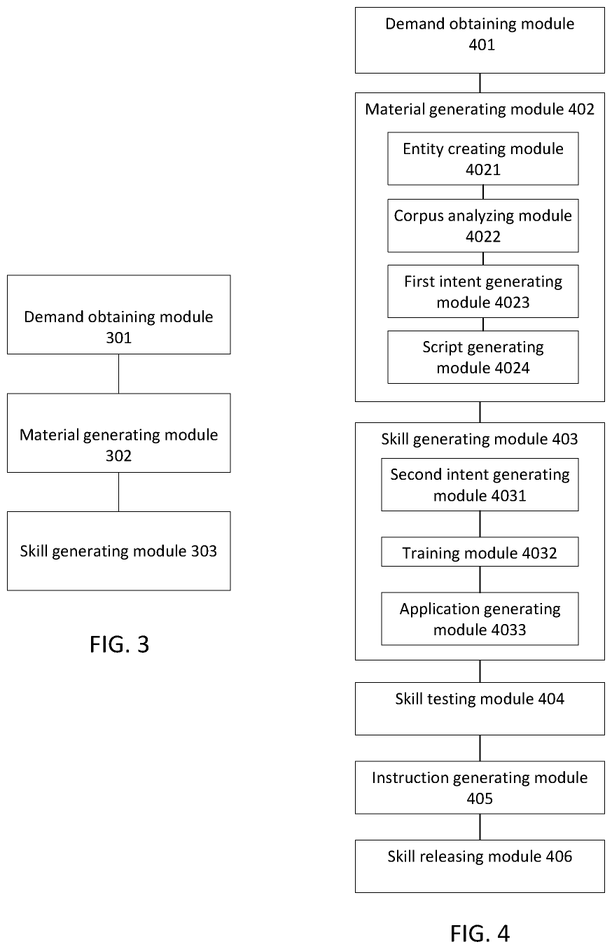

Referring to FIG. 3, a structural block diagram of a skill generating apparatus is illustrated according to some embodiments of the specification. The skill generating apparatus according to the embodiments may include: a demand obtaining module 301 configured to generate, according to a demand creating instruction and demand content data, a task corresponding to distribution target information; a material generating module 302 configured to create a material library according to a response instruction that responds to the task corresponding to the distribution target information; and a skill generating module 303 configured to determine a training material from the material library according to a skill training instruction to generate a skill according to the training material.

The skill generating apparatus may achieve online skill development and generation, enabling a full-link flow from demand creation to skill generation in a skill generation process to be completed online, making the monitoring of deadlines in the skill generation process to be more convenient, and the skill generation process traceable.

Referring to FIG. 4, a structural block diagram of a skill generating apparatus is illustrated according to other embodiments of the specification. The skill generating apparatus according to the embodiments may include: a demand obtaining module 401 configured to generate, according to a demand creating instruction and demand content data, a task corresponding to distribution target information; a material generating module 402 configured to create a material library according to a response instruction that responds to the task corresponding to the distribution target information; and a skill generating module 403 configured to determine a training material from the material library according to a skill training instruction to generate a skill according to the training material.

In some embodiments, the apparatus may further include: a skill testing module 404 configured to obtain a skill testing instruction, test the processed skill according to the skill testing instruction, and generate a testing result; and an instruction generating module 405 configured to generate a skill releasing instruction or a re-processing instruction according to the testing result.

In some embodiments, if the instruction generating module 405 generates a skill releasing instruction according to the testing result, the apparatus may further include: a skill releasing module 406 configured to generate skill releasing information according to the skill releasing instruction, wherein the skill releasing information may include the generated skill, and a script version and a training material version corresponding to the generated skill.

In some embodiments, the response instruction may include at least one of the following: an entity creating instruction, a natural language processing instruction, a script generating instruction, a natural language generating instruction, and a call interface generating instruction.

In some embodiments, if the response instruction includes an entity creating instruction, the material generating module 4021 may include an entity creating module 4021 configured to generate an entity in a dictionary of the material library according to the entity creating instruction, wherein the entity includes an entity name and entity attribute values.

In some embodiments, if the response instruction includes a natural language processing instruction, the material generating module 402 may include a corpus analyzing module 4022 configured to analyze a corpus through a natural language processing algorithm according to the natural language processing instruction; and a first intent generating module 4023 configured to generate intent data according to the analyzed corpus and store the intent data in the material library, wherein the intent data includes intent ID, intent name, and slots.

In some embodiments, if the response instruction includes a script generating instruction, the material generating module 402 may include a script generating module 4024 configured to, after the intent data in the material library is generated according to the analyzed corpus, generate script data according to the intent data and a preset script template and store the script data in the material library.

In some embodiments, the skill generating module 403 may include a second intent generating module 4031 configured to generate an intent according to a corpus in the training material; a training module 4032 configured to use the intent to train a preset operation determining model for determining an operation in response to an intent and script data; and an application generating module 4033 configured to generate an application including the skill according to the trained operation determining model and script data.

In some embodiments, when the training module 4032 uses the intents to train the script data, the training module 4032 determines, for each of the intents, corresponding script data according to the current intent; if the current intent is a new intent, update the script data according to the new intent so as to add script content corresponding to the new intent into the script data, until all intents are traversed, so as to complete the script data training.

The skill generating apparatus may achieve online skill development and generation, enabling a full-link flow from demand creation to skill generation in a skill generation process to be completed online, making the monitoring of deadlines in the skill generation process more convenient, and the skill generation process traceable.

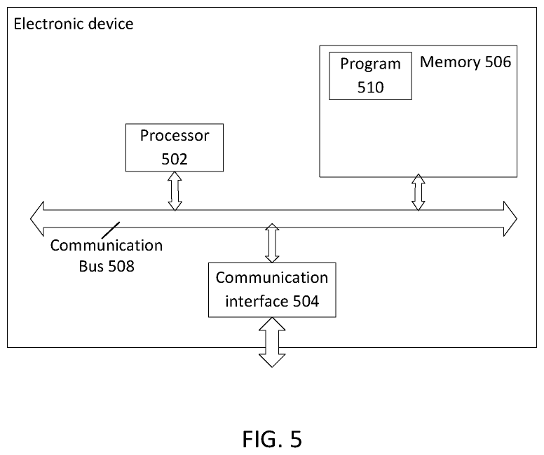

Referring to FIG. 5, a schematic structural diagram of an electronic device is illustrated according to some embodiments of the specification. The embodiments of the specification do not limit implementations of the electronic device. As shown in FIG. 5, the electronic device may include: a processor 502, a communication interface 504, a memory 506, and a communication bus 508.

In the illustrated embodiments, the processor 502, the communication interface 504, and the memory 506 may communicate with one another via the communication bus 508. The communication interface 504 is configured to communicate with other electronic devices. The processor 502 is configured to execute a program 510, and in one example, to execute relevant steps in the above embodiments of the skill generating methods. For example, the program 510 may include program code, and the program code includes computer operation instructions.

The processor 502 may be a Central Processing Unit (CPU), an Application Specific Integrated Circuit (ASIC), or one or more integrated circuits configured to implement embodiments of the specification. One or more processors may be included in the electronic device, and may be processors of the same type, e.g., one or more CPUs, or may be processors of different types, e.g., one or more CPUs and one or more ASICs. The memory 506 is configured to store the program 510. The memory 506 may include high-speed RAM, and may also include a non-volatile memory, e.g., at least one magnetic disk memory.

In some embodiments, the program 510 may be configured to cause the processor 502 to execute the following operations: generating, according to a demand creating instruction and demand content data, a task corresponding to distribution target information; creating a material library according to a response instruction that responds to the task corresponding to the distribution target information; and determining a training material from the material library according to a skill training instruction to generate a skill according to the training material.

In some embodiments, the program 510 is further configured to cause the processor 502 to obtain a skill testing instruction, test the processed skill according to the skill testing instruction, and generate a testing result; to generate a skill releasing instruction or a re-processing instruction according to the testing result.

In some embodiments, the program 510 is further configured to cause the processor 502 to, when generating a skill releasing instruction according to the testing result, generate skill releasing information according to the skill releasing instruction, wherein the skill releasing information may include the generated skill, and a script version and a training material version corresponding to the generated skill.

In some embodiments, the response instruction may include at least one of the following: an entity creating instruction, a natural language processing instruction, a script generating instruction, a natural language generating instruction, and a call interface generating instruction.

In some embodiments, the program 510 is further configured to cause the processor 502 to, when the response instruction includes an entity creating instruction, a task is generated and distributed according to the distribution target information, and a material library is created according to the response instruction responding to the task, generate an entity in a dictionary of the material library according to the entity creating instruction, wherein the entity includes an entity name and entity attribute values.

In some embodiments, the program 510 is further configured to cause the processor 502 to, when the response instruction includes a natural language processing instruction, a task is generated and distributed according to the distribution target information, and a material library is created according to the response instruction responding to the task, analyze a corpus through a natural language processing algorithm according to the natural language processing instruction; and to generate intent data according to the analyzed corpus and store the intent data in the material library, wherein the intent data includes intent ID, intent name, and slots.

In some embodiments, the program 510 is further configured to cause the processor 502 to, when the response instruction includes a script generating instruction and after the intent data in the material library is generated according to the analyzed corpus, generate script data according to the intent data and a preset script template and store the script data in the material library.

In some embodiments, the program 510 is further configured to cause the processor 502 to, when a training material is determined from the material library according to the skill training instruction so as to generate a skill according to the training material, generate an intent according to a corpus in the training material; to use the intent to train a preset operation determining model for determining an operation in response to an intent and script data; and to generate an application including the skill according to the trained operation determining model and the script data.

In some embodiments, the program 510 is further configured to cause the processor 502 to, when the intents are used to train the script data, determine, for each of the intents, corresponding script data according to the current intent; if the current intent is a new intent, update the script data according to the new intent so as to add script content corresponding to the new intent into the script data, until all intents are traversed, so as to complete the script data training.

The electronic device according to the present embodiment may achieve online skill development and generation, enabling a full-link flow from demand creation to skill generation in a skill generation process to be completed online, making the monitoring of deadlines in the skill generation process more convenient, and the skill generation process traceable.

It should be noted that, according to needs for implementation, each part/step described in the embodiments of the specification may be divided into more parts/steps, or two or more parts/steps or some operations of the parts/steps may be combined into a new part/step, so as to achieve the goal of the embodiments of the specification.

The above methods according to the embodiments of the specification may be implemented in hardware and firmware, or may be implemented as software or computer code stored in a storage medium (e.g., CD ROM, RAM, a floppy disk, a hard disk, or a magneto-optical disk), or may be implemented as computer code that is downloaded from the Internet, originally stored in a remote storage medium or non-transitory machine readable medium, and will be stored in a local storage medium. Therefore, the methods described in the specification may be processed by software stored on a storage medium for a general-purpose computer, a special-purpose computer, or a programmable or special-purpose hardware (e.g., ASIC or FPGA). It should be understood that the computer, the processor, a controller of a micro-processor, or programmable hardware comprises a storage component capable of storing or receiving software or computer code (e.g., RAM, ROM, flash memory, etc.). When the software or computer code is accessed and executed by the computer, the processor, or the hardware, the skill generating method described in the specification is implemented. In addition, when a general-purpose computer accesses the code used for implementing the skill generating method in the specification, the execution of the code transforms the general-purpose computer into a special-purpose computer for implementing the skill generating method in the specification.

One of ordinary skill in the art should understand that the units and method steps in each example described with reference to the embodiments of the specification may be implemented by electronic hardware or a combination of computer software and electronic hardware. Whether these functions are implemented in a hardware manner or a software manner depends on applications and design restrictions of the design of the technical solutions. One of ordinary skill in the art may implement the described functions by using different methods for each application, but such implementation may not be deemed exceeding the scope of the embodiments of the specification.

The implementation manners are only used to describe the embodiments of the specification, rather than limiting the embodiments of the specification. Various modifications and variations may be made by one of ordinary skill in the art without departing from the spirit and scope of the embodiments of the specification. Therefore, all equivalent technical solutions shall fall in the scope of the embodiments of the specification, and the scope of the embodiments of the specification shall be subject to the claims.

1. A skill generating method, implementable by a computing device, the method comprising:
generating, according to a demand creating instruction and demand content data, a task corresponding to distribution target information;
creating a material library according to a response instruction that responds to the task corresponding to the distribution target information; and
determining a training material from the material library according to a skill training instruction to generate a skill according to the training material.

2. The method according to claim 1, further comprising:
testing the generated skill according to a skill testing instruction, and generating a testing result; and
generating a skill releasing instruction or a re-processing instruction according to the testing result.

3. The method according to claim 2, wherein a skill releasing instruction is generated according to the testing result, and the method further comprises:
generating skill releasing information according to the skill releasing instruction, wherein the skill releasing information comprises the generated skill, and a script version and a training material version corresponding to the generated skill.

4. The method according to claim 1, wherein the response instruction comprises at least one of the following: an entity creating instruction, a natural language processing instruction, a script generating instruction, a natural language generating instruction, and a call interface generating instruction.

5. The method according to claim 4, wherein the response instruction comprises an entity creating instruction, and the creating a material library according to a response instruction responding to the task comprises:
generating an entity in a dictionary of the material library according to the entity creating instruction, wherein the entity comprises an entity name and an entity attribute value.

6. The method according to claim 4, wherein the response instruction comprises a natural language processing instruction, and the creating a material library according to a response instruction responding to the task comprises:
analyzing a corpus through a natural language processing algorithm according to the natural language processing instruction; and
generating intent data according to the analyzed corpus and storing the intent data in the material library, wherein the intent data comprises intent identifier (ID), intent names, and slots.

7. The method according to claim 6, wherein the response instruction further comprises a script generating instruction, and the creating a material library according to a response instruction responding to the task further comprises:
generating script data according to the intent data and a preset script template and storing the script data in the material library.

8. The method according to claim 1, wherein the determining a training material from the material library according to a skill training instruction to generate a skill according to the training material comprises:
generating a plurality of intents according to corpora in the training materials;
training an operation determining model and script data by using the plurality of intents, the operation determining model being used to determine an operation in response to an intent; and
generating an application comprising the skill according to the trained operation determining model and script data.

9. The method according to claim 8, wherein the training script data by using the plurality of intents comprises:
for each of the plurality of intents, determining corresponding script data according to the intent being currently processed; and
in response to determining that the intent being currently processed is a new intent, updating the script data according to the intent being currently processed to add script content corresponding to the new intent into the script data, until all of the plurality of intents are traversed.

10. A skill generating apparatus, comprising one or more processors and one or more non-transitory computer-readable memories coupled to the one or more processors and configured with instructions executable by the one or more processors to cause the system to perform operations comprising:
generating, according to a demand creating instruction and demand content data, a task corresponding to distribution target information;
creating a material library according to a response instruction that responds to the task corresponding to the distribution target information; and
determining a training material from the material library according to a skill training instruction to generate a skill according to the training material.

11. The apparatus according to claim 10, wherein the operations further comprise:
testing the generated skill according to a skill testing instruction, and generating a testing result; and
generating a skill releasing instruction or a re-processing instruction according to the testing result.

12. The apparatus according to claim 11, wherein a skill releasing instruction is generated according to the testing result, and the operations further comprise:
generating skill releasing information according to the skill releasing instruction, wherein the skill releasing information comprises the generated skill, and a script version and a training material version corresponding to the generated skill.

13. The apparatus according to claim 10, wherein the response instruction comprises at least one of the following: an entity creating instruction, a natural language processing instruction, a script generating instruction, a natural language generating instruction, and a call interface generating instruction.

14. The apparatus according to claim 13, wherein the response instruction comprises an entity creating instruction, and the creating a material library according to a response instruction responding to the task comprises:
generating an entity in a dictionary of the material library according to the entity creating instruction, wherein the entity comprises an entity name and an entity attribute value.

15. The apparatus according to claim 13, wherein the response instruction comprises a natural language processing instruction, and the creating a material library according to a response instruction responding to the task comprises:
analyzing a corpus through a natural language processing algorithm according to the natural language processing instruction; and
generating intent data according to the analyzed corpus and storing the intent data in the material library, wherein the intent data comprises intent identifier (ID), intent names, and slots.

16. The apparatus according to claim 15, wherein the response instruction further comprises a script generating instruction, and the creating a material library according to a response instruction responding to the task further comprises:
generating script data according to the intent data and a preset script template and storing the script data in the material library.

17. The apparatus according to claim 10, wherein the determining a training material from the material library according to a skill training instruction to generate a skill according to the training material comprises:
generating a plurality of intents according to corpora in the training materials;
training an operation determining model and script data by using the plurality of intents, the operation determining model being used to determine an operation in response to an intent; and
generating an application comprising the skill according to the trained operation determining model and script data.

18. The apparatus according to claim 17, wherein the training script data by using the plurality of intents comprises:
for each of the plurality of intents, determining corresponding script data according to the intent being currently processed; and
in response to determining that the intent being currently processed is a new intent, updating the script data according to the intent being currently processed to add script content corresponding to the new intent into the script data, until all of the plurality of intents are traversed.

19. A non-transitory computer-readable storage medium configured with instructions executable by one or more processors to cause the one or more processors to perform operations comprising:
generating, according to a demand creating instruction and demand content data, a task corresponding to distribution target information;
creating a material library according to a response instruction that responds to the task corresponding to the distribution target information; and
determining a training material from the material library according to a skill training instruction to generate a skill according to the training material.

20. The non-transitory computer-readable storage medium according to claim 19, wherein the operations further comprise:
testing the generated skill according to a skill testing instruction, and generating a testing result; and
generating a skill releasing instruction or a re-processing instruction according to the testing result.
